(19) United States
(12) Patent Application Publication
(10) Pub. No.: US 2009/0053675 A1
(43) Pub. Date: Feb. 26, 2009

(54) Refractory model system an indirect system for capturing tooth and/or dental implant shapes and relative positions utilizing pre-fabricated parts and refractory cements

(75) Inventor: Wiliam Gary Wilcox, Glastonbury, CT (US)

Correspondence Address: Nancy L. Moskow, ICI, 26 Portland Road, Marlborough, CT, 06447, US

(73) Assignee: Inventions Capitalized, Inc.

(21) Appl. No.: 12/221,835

(22) Filed: Aug. 7, 2008

Related U.S. Application Data
(60) Provisional application No. 60/935,397, filed on Aug. 10, 2007.

(51) Int. Cl. A61C 13/007

(52) U.S. Cl. 433/201.1

(57) ABSTRACT

This is a system which answers the need to provide pre-fabricated components of various materials that constitute a unique Refractory Model System designed to be used in, but not limited to, the fabrication of fixed dental restorative and prosthetic devices.

### BACKGROUND

There are currently many techniques in use for the fabrication of metallic, non-metallic and hybrid fixed dental restorations and prostheses, requiring custom fabrication of supportive understructure frameworks upon which esthetic veneering materials may be applied to produce life-like, functional fixed dental prostheses. This is a time-consuming and, therefore, expensive process that requires the utilization of highly trained technicians skilled in the various steps involved in designing, sculpting and processing the elements that must come together to create a dental bridge framework.

In addition, the fabrication of a non-metallic framework requires that the laboratory either makes a large capital investment to obtain the necessary equipment to do the work on-site or is forced to use of an off-site commercial laboratory, causing delay, and reducing both control over the case and profit from it.

Thus, there exists a need to provide a system for the production of non-metallic crown and bridge understructures utilizing, to the greatest extent possible, pre-fabricated components that can be inventoried on-site, the use of which does not require a large capital investment for new equipment.

Critical to the success of any indirect dental crown or bridge fabrication, i.e., that which is fabricated outside the mouth and then inserted for use, must be a means for accurately recording the dimensions and relationships of the prepared natural tooth abutments or implant abutments that will be used to support the dental prosthetic bridge. Likewise, in the case of a single crown, it is crucial to accurately record the shape and position of the prepared tooth or implant abutment relative to the unprepared teeth. Materials must be used that will not allow the loss of this accuracy during the fabrication process.

### SUMMARY

This is a system of pre-fabricated components of various materials that constitute a unique Refractory Model System designed to be used in, but not limited to, the fabrication of fixed dental restorative and prosthetic devices.

The physical forms of the components are determined by their application and include, without being limited to, Universal Tray Bodies, Universal Analog Receptacle Plugs, Universal Plug Nuts, Universal Plug Washers, and Specific Abutment Analogs.

A Specific Tray System Abutment Analog (Analog) is manufactured to match a particular implant abutment and, therefore, to fit precisely into the impression of that abutment made in the mouth. A different Analog is required for each different shape of implant abutment manufactured.

An Analog can be easily modified for use with the impression of a prepared natural tooth, broadening the applicability of the system. The Analog is received into the matched receptacle in the Universal Analog Receptacle Plug (Plug).

Two Plugs are positioned in a Universal Tray Body (Tray Body) to passively receive one or two Analogs, depending on the application. The Tray Body has a hole and a slot cut into it to receive the Plugs. The Universal Plug Nuts are tightened down on the Plugs to lock their positions on the Tray Body. A Universal Plug Washer (Washer) is used as a spacer for the Plug and Nut that engage the hole.

The simplest form of the assembled Tray consists of a single Tray Body and two Analog/Plug Receptacle/Nut assemblies, one of which utilizes the Washer. Should more than two Abutment Analogs be necessary, a second embodiment of the present invention could be constructed, whereby the undersides of two Tray Bodies are apposed in the Overlap Areas of the Plug holes and fixed in to position by an Analog/Receptacle/Nut assembly without the need for a washer. Analogs are fixed into the Receptacle/Nut assembly by the use a refractory cement.

### BRIEF DESCRIPTION OF DRAWINGS

FIG. 1a is a superior view of the assembled Tray, consisting of one tray body, two Plugs, one Washer, and two Nuts, the first embodiment of the present invention.

FIG. 1b is a lateral view of the assembled Tray, consisting of one tray body, two Plugs, one Washer, and two Nuts. Clearly demonstrated is the function of the Washer replacing the removed material of the Tray Body overlap area in this, the first embodiment of the present invention.

FIG. 1c is a supero-lateral-Washer-end view of the assembled Tray consisting of one tray body, two Plugs, one Washer, and two Nuts, the first embodiment of the present invention.

FIG. 2a is a lateral-Washer-end view of the Tray Body (20) showing the Tray Body overlap area (23), the Positioning Slot for the Universal Analog Receptacle Plug (22), and the Positioning Hole for the Universal Receptacle Plug (21) of the first embodiment of the current invention.

FIG. 2b is a contra-lateral view of said Tray Body of the present invention shown In FIG. 2a.

FIG. 2c is a lateral view of said Tray Body of the present invention.

FIG. 2d is a lateral view of the current embodiment of said Tray Body of the present invention.

FIG. 2e is superior lateral view of the Tray Body of the present invention

FIG. 2f is a lateral end view of said Tray Body of the present invention.

FIG. 2g is a sectional view of said Tray Body of the present invention.

FIG. 2h is a sectional view of said Tray Body of the present invention.

FIG. 3a is a superior view of the Universal analog Receptacle Plug of the present

FIG. 3b is a lateral view of said Universal analog Receptacle Plug of the present invention

FIG. 3c is an inferior view of said Universal Analog Receptacle Plug of the present invention

FIG. 3d is a lateral view of said Universal analog Receptacle Plug of the present invention.

FIG. 3e is a supero-lateral view of said Universal Analog Receptacle Plug of the present invention.

FIG. 3f is an infero-lateral view of said Universal Analog Receptacle Plug of the present invention.

FIG. 4a is an oblique view of the Plug Washer of the present invention.

FIG. 5a is an oblique view of the Universal Plug Nut of the present invention.

FIG. 6a is a lateral view of said Specific Tray System Abutment Analog of the present invention.

FIG. 6b is a lateral view of the Specific Tray System Abutment Analog of the present invention.

FIG. 6s is an oblique view of the Universal Plug Nut of the present invention.

### DETAILED DESCRIPTION

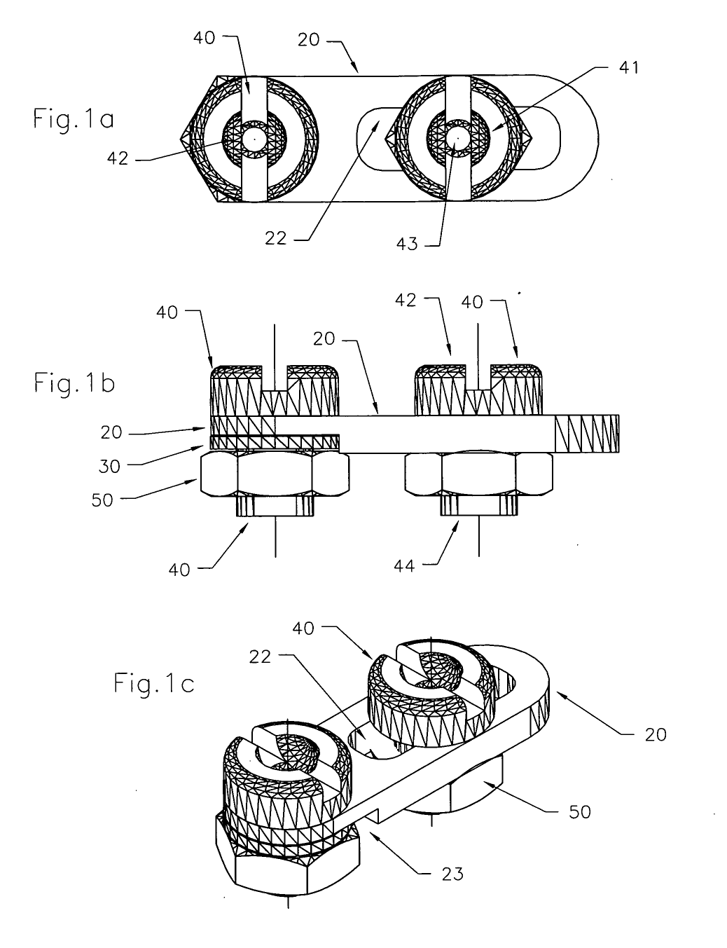

FIG. 1a is a superior view of the assembled Tray, consisting of one tray body, two Plugs, one Washer, and two. Nuts, the first embodiment of the present invention.

FIG. 1b is a lateral view of the assembled Tray, consisting of one tray body, two Plugs, one Washer, and two Nuts. Clearly demonstrated is the function of the Washer replacing the removed material of the Tray Body overlap area in this, the first embodiment of the present invention.

FIG. 1c is a supero-lateral-Washer-end view of the assembled Tray consisting of one tray body, two Plugs, one Washer, and two Nuts, the first embodiment of the present invention.

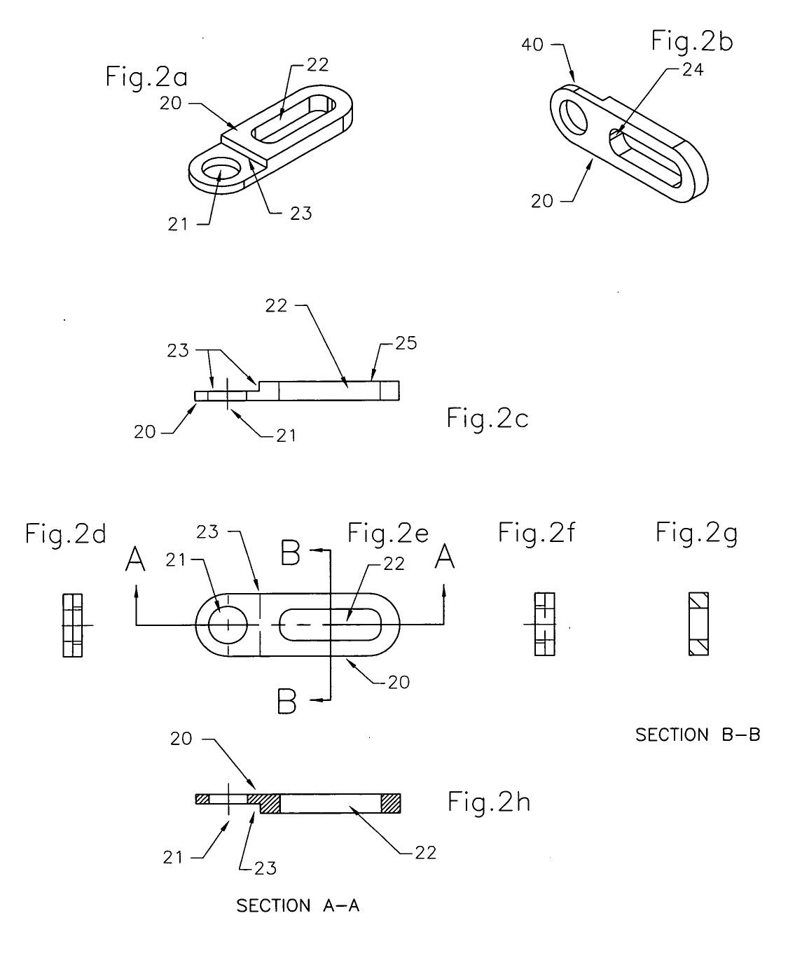

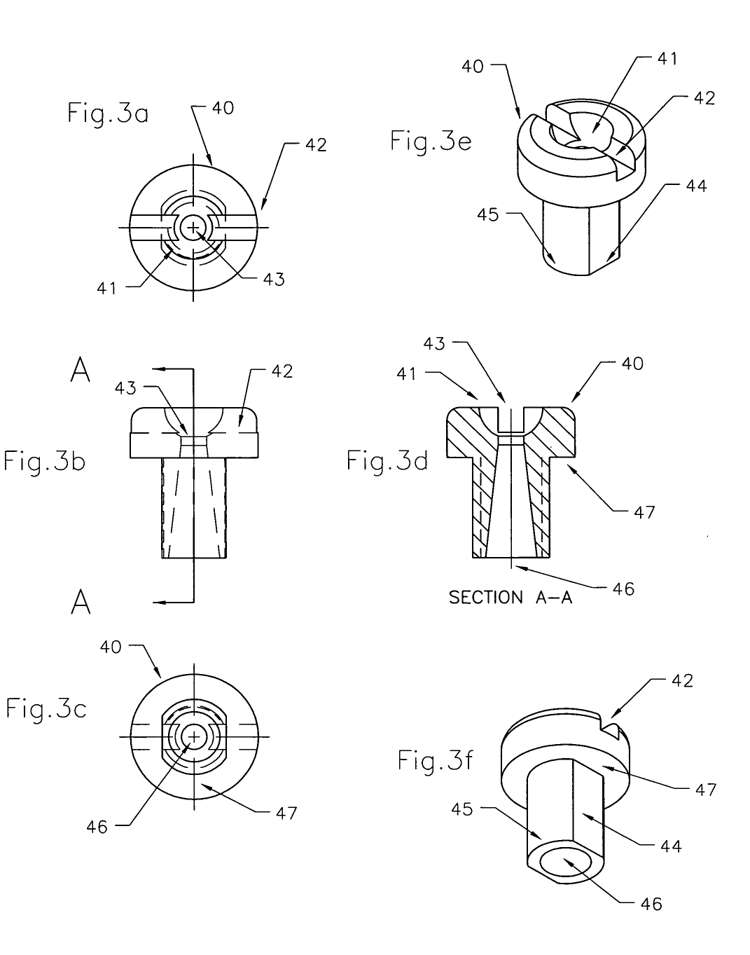

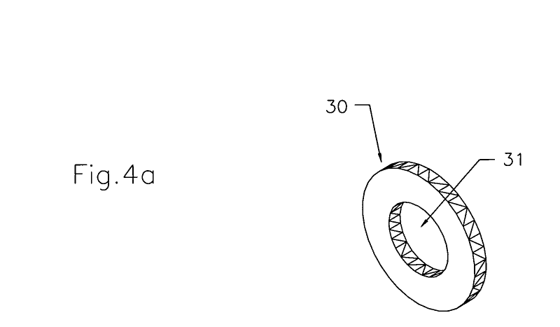

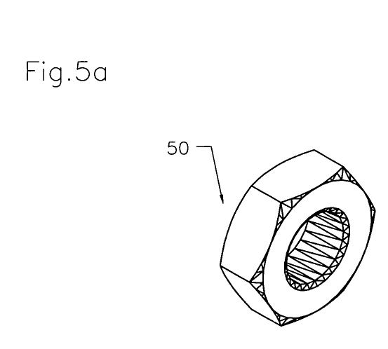

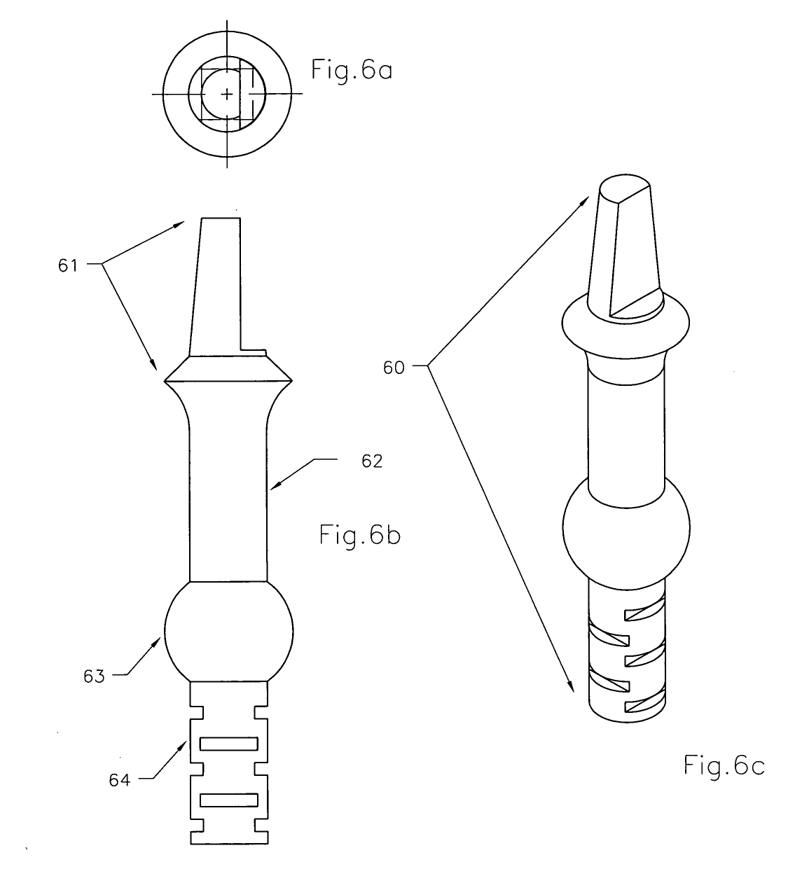

FIG. 2a is a lateral-Washer-end view of the Tray Body (20) showing the Tray Body overlap area (23), the Positioning Slot for the Universal Analog Receptacle

Plug (22), and the Positioning Hole for the Universal Receptacle Plug (21) of the first embodiment of the current invention.

FIG. 2b is a contra-lateral view of said Tray Body of the present invention shown in FIG. 2a.

While the instant disclosure has been described with reference to one or more exemplary embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this invention, but that the invention will include all embodiments falling within and beyond the scope of the current patent application.

What is claimed is:

1) A system of pre-fabricated components of various materials that constitute a unique Refractory Model System designed to be used in the fabrication of fixed dental restorative and prosthetic devices through methods of application to include, without being limited to:
A Specific Tray System Abutment Analog (Analog) manufactured to match a particular implant abutment and therefore, to fit precisely into the impression of that abutment made in the mouth for which;
A different Analog is required for each different shape of implant abutment Manufactured, and may be modified for use with the impression of a prepared natural tooth, broadening the applicability of the system;
the Analog is received into the matched receptacle in the Universal Analog Receptacle Plug (Plug).

2) The apparatus as specified in claim 1
wherein the use of custom made Analog allows for additional specifications as follows:
Two Plugs are positioned in a Universal Tray Body (Tray Body) to passively receive one or two Analogs for which the Tray Body has a hole and a slot cut into it to receive the Plugs, then tightened by the Universal Plug Nuts to lock their positions on the Tray Body

3) The apparatus as specified in claim 2
wherein the Universal Plug Washer (Washer) is used as a spacer for the Plug and Nut that engage the hole in the cutaway portion of the Tray Body.

4) The apparatus as specified in claim 3
wherein the he simplest form of the assembled Tray consists of a single Tray Body and two Analog/Plug Receptacle/Nut assemblies, one of which utilizes the Washer. Should more than two Abutment Analogs be necessary, a second embodiment of the present invention could be constructed, whereby the undersides of two Tray Bodies are apposed in the Overlap Areas of the Plug holes and fixed in to position by an Analog/Receptacle/Nut assembly without the need for a washer.

5) The assembly in claim 4, further comprising
the modification of the Abutment Analogs for use with natural teeth as specified in claim 1 includes the use of a refractory cement material to to capture the shape of the prepared tooth (teeth) in the specified impression.
